(19) United States
(12) Patent Application Publication
(10) Pub. No.: US 2024/0004211 A1
(43) Pub. Date: Jan. 4, 2024

(54) ALIGNMENT KEY INCLUDING MULTI-FOCAL META-LENS AND ALIGNMENT APPARATUS INCLUDING THE ALIGNMENT KEY

(71) Applicants: SAMSUNG ELECTRONICS CO., LTD., Suwon-si (KR); UNIVERSITY OF MASSACHUSETTS, Boston, MA (US)

(72) Inventors: Seunghoon Han, Suwon-si (KR); Amir Arbabi, Amherst, MA (US); Andrew McClung, Northampton, MA (US)

(73) Assignees: SAMSUNG ELECTRONICS CO., LTD., Suwon-si (KR); UNIVERSITY OF MASSACHUSETTS, Boston, MA (US)

(21) Appl. No.: 18/217,073

(22) Filed: Jun. 30, 2023

Related U.S. Application Data
(60) Provisional application No. 63/357,779, filed on Jul. 1, 2022.

(30) Foreign Application Priority Data
May 22, 2023 (KR) 10-2023-0065878

(51) Int. Cl. G02B 27/62; G02B 7/00; G02B 3/10; G02B 1/00

(52) U.S. Cl. CPC G02B 27/62; G02B 7/005; G02B 3/10; G02B 1/002; B82Y 20/00

(57) ABSTRACT

An alignment key includes: a first multi-focal meta-lens that includes a plurality of first nanostructures, the plurality of first nanostructures having a first shape distribution that forms two different focal lengths with respect to a first set of regions in the first multi-focal meta-lens; and a second multi-focal meta-lens that includes a plurality of second nanostructures, the plurality of second nanostructures having a second shape distribution that forms the two different focal lengths with respect to a second set of regions in the second multi-focal meta-lens.

### CROSS-REFERENCE TO RELATED APPLICATION

This application is based on and claims priority under 35 U.S.C. § 119 This application is based on and claims the benefit of U.S. Provisional Patent Application No. 63/357,779, filed on Jul. 1, 2022, in the United States Patent and Trademark Office, and claims priority under 35 U.S.C. § 119 to Korean Patent Application No. 10-2023-0065878, filed on May 22, 2023, in the Korean Intellectual Property Office, the disclosures of which are incorporated herein by reference in their entirety.

### FIELD

The disclosure relates to an alignment key and an alignment apparatus including the same.

### BACKGROUND

The degree of integration of various conventional integrated circuit elements including memories, driving integrated circuits (IC), logic elements, and/or image sensors, has increased day by day, and accordingly, the size of electronic elements provided in the integrated circuit elements has decreased. Also, conventional optical elements are manufactured on a wafer substrate to be flat in a nanostructure.

The conventional electronic and optical elements, which are formed on different substrates, may be integrated as one package by using align marks provided on respective substrates. The align marks may include patterns transmitting and reflecting light, and a degree of alignment may be checked by detecting transmitting, reflecting, and scattering patterns according to an overlay shape of the align marks facing each other.

The shape dimensions of patterns provided on alignment marks are also reduced to improve the accuracy and precision of alignment, but it is difficult to implement the accuracy and precision of measurement in a level of sub-microns, for example, 100 nm, due to optical resolution limitations.

### SUMMARY

Provided are an alignment key and an alignment apparatus including the same, wherein the alignment key may increase the accuracy and precision of alignment when manufacturing an electronic element.

Additional aspects will be set forth in part in the description which follows and, in part, will be apparent from the description, or may be learned by practice of the presented embodiments.

An alignment key may include: a first multi-focal meta-lens that may include a plurality of first nanostructures, the plurality of first nanostructures having a first shape distribution that forms two different focal lengths with respect to a first set of regions in the first multi-focal meta-lens; and a second multi-focal meta-lens that may include a plurality of second nanostructures, the plurality of second nanostructures having a second shape distribution that forms the two different focal lengths with respect to a second set of regions in the second multi-focal meta-lens.

The two different focal lengths may include a first focal length that is a focal length for light incident to a first region of the first set of regions, the first region having a distance equal to or greater than d1 and equal to or less than d2 from a center of the first multi-focal meta-lens. The two different focal lengths may include a second focal length that is a focal length for light incident to a second region of the first set of regions, the second region having a distance equal to or greater than d3 and equal to or less than d4 from the center of the first multi-focal meta-lens. The second focal length may be different than the first focal length. d1 may be less than d2 that may be less than d3 that may be less than d4. The second multi-focal meta-lens may be configured to exhibit a same focal length performance as the first multi-focal meta-lens.

The second focal length may be greater than the first focal length.

Each of the first region and the second region may have a same numerical aperture.

Each of the first region and the second region may have positive refractive power.

The first region may negative refractive power. The second region may have positive refractive power.

The second shape distribution may be configured so that the second multi-focal meta-lens has an optical performance of deflecting and emitting incident light.

The first set of regions may include: a first region having negative refractive power, the first region corresponding to a first focal length of the two different focal lengths, the first region having a circular shape with a first diameter; and a second region spaced apart from the first region in a first direction, the second region having positive refractive power, the second region corresponding to a second focal length of the two different focal lengths, the second region having a circular shape with a second diameter. The second set of regions may include: a third region spaced apart from and facing the first region in a second direction that is perpendicular the first direction, the third region having positive refractive power, the third region corresponding to the second focal length, the third region having the circular shape with the second diameter; and a fourth region spaced apart from and facing the second region in the second direction, the fourth region having negative refractive power, the fourth region corresponding to the first focal length, the fourth region having the circular shape with the first diameter.

Each of the first region, the second region, the third region, and the fourth region may have a same numerical aperture.

An alignment apparatus may include: a light source; a first structure that may include a first multi-focal meta-lens, the first multi-focal meta-lens comprising a plurality of first nanostructures, the plurality of first nanostructures having a first shape distribution that forms two different focal lengths with respect to a first set of regions in the first multi-focal meta-lens; a second structure that may include a second multi-focal meta-lens, the second multi-focal meta-lens comprising a plurality of second nanostructures, the plurality of second nanostructures having a second shape distribution that forms the two different focal lengths with respect to a second set of regions in the second multi-focal meta-lens; an imaging device configured to measure a beam pattern that is formed after light irradiated from the light source passes through the first multi-focal meta-lens and the second multi-focal meta-lens; a processor configured to analyze an alignment state between the first structure and the second structure from a measurement result of the imaging device; and a driver configured to drive at least one of the first structure or the second structure to change a relative positional relationship between the first structure and the second structure, the processor being further configured to control the driver.

The two different focal lengths may include a first focal length that is a focal length for light incident to a first region of the first set of regions, the first region having a distance equal to or greater than d1 and equal to or less than d2 from a center of the first multi-focal meta-lens. The two different focal lengths may include a second focal length that is a focal length for light incident to a second region of the first set of regions, the second region having a distance equal to or greater than d3 and equal to or less than d4 from the center of the first multi-focal meta-lens. The second focal length may be different than the first focal length. d1 may be less than d2 that may be less than d3 that may be less than d4. The second multi-focal meta-lens may be configured to exhibit a same focal length performance as the first multi-focal meta-lens.

The second focal length may be greater than the first focal length.

Each of the first region and the second region may have a same numerical aperture.

Each of the first region and the second region may have positive refractive power.

The processor may be further configured to, at a position where the first structure and the second structure are positioned so that a distance between the first multi-focal meta-lens and the second multi-focal meta-lens is a sum of the first focal length and a second focal length, analyze a misalignment state between the first structure and the second structure in a direction perpendicular to an optical axis.

The first region may have negative refractive power. The second region may have positive refractive power.

The processor may be further configured to, at a position where the first structure and the second structure are positioned so that a distance between the first multi-focal meta-lens and the second multi-focal meta-lens is a difference between the first focal length and a second focal length, analyze a misalignment state between the first structure and the second structure in a direction perpendicular to an optical axis.

The first set of regions may include: a first region having negative refractive power, the first region corresponding to a first focal length of the two different focal lengths, the first region having a circular shape with a first diameter; and a second region spaced apart from the first region in a first direction, the second region having positive refractive power, the second region corresponding to a second focal length of the two different focal lengths, the second region having a circular shape with a second diameter. The second set of regions may include: a third region spaced apart from and facing the first region in a second direction that is perpendicular the first direction, the third region having positive refractive power, the third region corresponding to the second focal length, the third region having the circular shape with the second diameter; and a fourth region spaced apart from and facing the second region in the second direction, the fourth region having negative refractive power, the fourth region corresponding to the first focal length, the fourth region having the circular shape with the first diameter.

Each of the first region, the second region, the third region, and the fourth region may have a same numerical aperture.

The processor may be further configured to analyze a distance between the first structure and the second structure in an optical axis direction from the measurement result of the imaging device.

### BRIEF DESCRIPTION OF THE DRAWINGS

The above and other aspects, features, and advantages of certain embodiments will be more apparent from the following description taken in conjunction with the accompanying drawings, in which:

FIG. 1 shows a schematic structure of an alignment key according to an embodiment;

FIG. 2 is a plan view illustrating a schematic structure of a first multi-focal meta-lens provided in an alignment key according to an embodiment;

FIG. 3 is a plan view illustrating a schematic structure of a second multi-focal meta-lens provided in an alignment key according to an embodiment;

FIGS. 4A to 4C show examples of shapes of a nanostructure provided in an alignment key according to an embodiment;

FIG. 5 shows an example of an optical path in a case where a pair of multi-focal meta-lenses are accurately aligned in an alignment key according to an embodiment;

FIGS. 6A to 6D show, according to various alignment states, an example of an action of an equivalent optical system configured by a second region of a first multi-focal meta-lens and a third region of a second multi-focal meta-lens in an alignment key according to an embodiment;

FIGS. 7A to 7C are diagrams of a computer simulation of beam patterns of light imaged by an imaging device, the light transmitting an alignment key, according to various arrangement states of a first multi-focal meta-lens and a second multi-focal meta-lens provided in the alignment key according to an embodiment;

FIG. 8 shows an example of a schematic structure of an alignment key according to another embodiment and an optical path in a case where a pair of multi-focal meta-lenses provided in the alignment key are accurately aligned;

FIG. 9 shows an example of a schematic structure of an alignment key according to another embodiment and an optical path in a case where a pair of multi-focal meta-lenses provided in the alignment key are accurately aligned;

FIGS. 10A to 10D are diagrams of a computer simulation of beam patterns of light imaged by an imaging device, the light transmitting an alignment key, according to various arrangement states of a first multi-focal meta-lens and a second multi-focal meta-lens provided in the alignment key according to an embodiment;

FIG. 11 shows an example of a schematic structure of an alignment key according to another embodiment and an optical path in a case where a pair of multi-focal meta-lenses provided in the alignment key are accurately aligned;

FIG. 12 shows an example of a schematic structure of an alignment key according to another embodiment and an optical path in a case where a pair of multi-focal meta-lenses provided in the alignment key are accurately aligned;

FIGS. 13A and 13B are plan views respectively showing schematic structures of a first multi-focal meta-lens and a second multi-focal meta-lens provided in the alignment key of FIG. 12;

FIGS. 14A to 14J are diagrams of a computer simulation of beam patterns of light imaged by an imaging device, the light transmitting an alignment key, according to various arrangement states of the first multi-focal meta-lens and the second multi-focal meta-lens provided in the alignment key of FIG. 12;

FIG. 15 is a block diagram illustrating a schematic configuration of an alignment apparatus according to an embodiment;

FIG. 16 is a cross-sectional view illustrating a schematic configuration of an apparatus including an alignment key according to an embodiment; and

FIGS. 17 to 20 are diagrams schematically showing examples where an alignment key according to an embodiment is used.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The following will now be described more fully with reference to the accompanying drawings, in which embodiments are shown. The embodiments may, however, be embodied in many different forms and should not be construed as being limited to the embodiments set forth herein. Like reference numerals in the drawings denote like elements, and sizes of components in the drawings may be exaggerated for convenience of explanation.

In the following, when a component, such as a layer, a film, a region, or a plate, is referred to as being “on” another component, the component can be directly on the other component or intervening components may be present thereon.

While such terms as “first,” “second,” etc., may be used to describe various components, the terms are used to distinguish one component from another. The terms are not intended to limit that the materials or structures of the components are different.

An expression used in the singular encompasses the expression of the plural, unless it has a clearly different meaning in the context. Also, when a certain portion “includes” a certain component, this means that other components may be further included without being excluded unless otherwise stated.

In addition, a term such as “ . . . unit” and “module” means a unit that processes at least one function or operation, which may be implemented as hardware or software or a combination of hardware and software.

The use of the terms “a” and “an” and “the” and similar referents in the context are to be construed to cover both the singular and the plural.

Steps of all methods described herein can be performed in any suitable order unless otherwise indicated herein or otherwise clearly contradicted by context. The use of any and all examples, or exemplary language (e.g., “such as”) provided herein, is intended merely to better illuminate the disclosed embodiments and does not pose a limitation on the scope of the disclosed embodiments unless otherwise claimed.

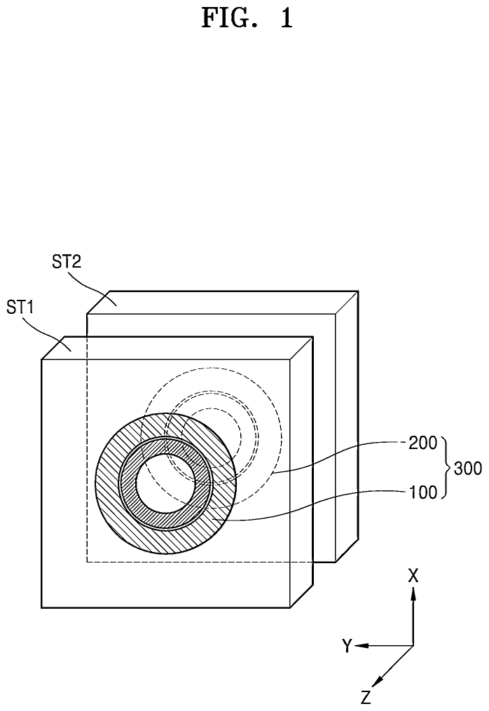

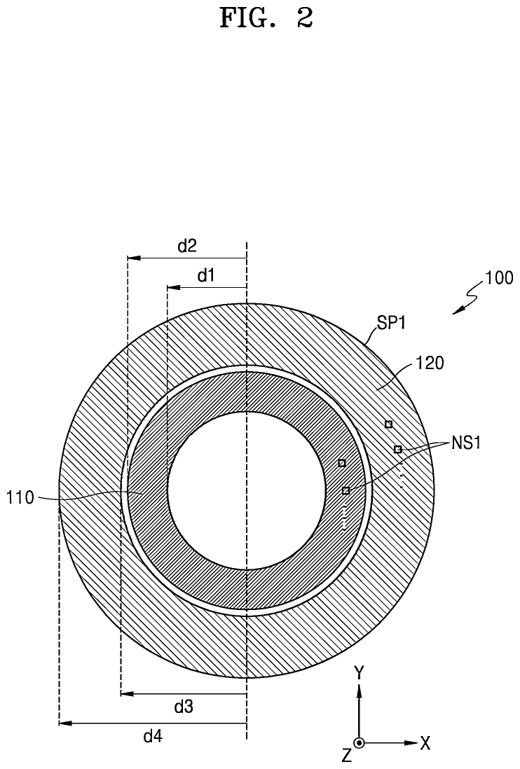

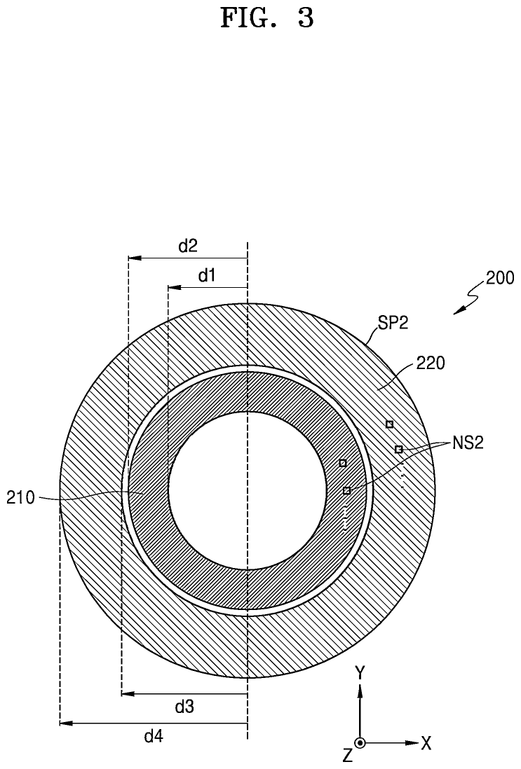

FIG. 1 shows a schematic structure of an alignment key according to an embodiment. FIG. 2 is a plan view illustrating a schematic structure of a first multi-focal meta-lens provided in an alignment key according to an embodiment, and FIG. 3 is a plan view illustrating a schematic structure of a second multi-focal meta-lens provided in an alignment key according to an embodiment.

An alignment key 300 may include a pair of multi-focal meta-lenses. The pair of multi-focal meta-lenses may be dividedly arranged in structures to be bonded in an aligned manner as one package by using the alignment key 300. As shown in FIG. 1, the alignment key 300 may include a first multi-focal meta-lens 100 and a second multi-focal meta-lens 200, which are arranged to face each other. The first multi-focal meta-lens 100 may be provided in a first structure ST1, and the second multi-focal meta-lens 200 may be provided in a second structure ST2. A metal pattern, an insulating pattern, a semiconductor pattern, or other pattern for forming electronic elements to be integrally formed by using the alignment key 300 may be arranged in each of the first structure ST1 and the second structure ST2, and such a structure is omitted in drawings for convenience.

The first multi-focal meta-lens 100 may include a plurality of nanostructures NS1, and may represent two different focal lengths by the shape and arrangement of the plurality of nanostructures NS1. The plurality of nanostructures NS1 may be arranged on a first support layer SP1, and the shapes and arrangements of the plurality of nanostructures NS1 may be determined to form different focal lengths in different regions on the first support layer SP1. The first support layer SP1 and a second support layer SP2 may include materials respectively having a different refractive index from those of a first nanostructure NS1 and a second nanostructure NS2. The first support layer SP1 and the second support layer SP2 may be separate configurations from the first structure ST1 and the second structure ST2 shown in FIG. 1, to respectively support the first nanostructure NS1 and the second nanostructure NS2, or may respectively be a portion of the first structure ST1 and the second structure ST2.

The first multi-focal meta-lens 100 may include a first region 110 and a second region 120. The first region 110 and the second region 120 may be concentric annular regions. The first multi-focal meta-lens 100 may represent a first focal length f1 for light incident to the first region 110, which has a distance equal to or greater than d1 and equal to or less than d2 from a center of the first multi-focal meta-lens 100, and may represent a second focal length f2 for light incident to the second region 120, which has a distance equal to or greater than d3 and equal to or less than d4 from the center of the first multi-focal meta-lens 100 and is different from the first focal length f1. Here, d1, d2, d3, and d4 are positive numbers having a relationship that d1<d2<d3<d4, and are not particularly limited. For example, d1 may be close to 0, that is, the first region 110 may also be a circular region. Both of the first region 110 and the second region 120 may show positive refractive power, and the second focal length f2 may be greater than the first focal length f1. However, the disclosed embodiments are not limited thereto. A combination of other types of refractive power may be included, and a focal distance relationship may also be changed. The first region 110 and the second region 120 may have the same numerical aperture. However, the disclosed embodiments are not limited thereto.

The second multi-focal meta-lens 200 may include a plurality of nanostructures NS2. The plurality of nanostructures NS2 may be arranged on the second support layer SP2, and the shapes and arrangements of the plurality of nanostructures NS2 may be determined to form different focal lengths in different regions on the second support layer SP2. The second multi-focal meta-lens 200 may have a focal length performance for each region, which is the same as that of the first multi-focal meta-lens 100.

In the second multi-focal meta-lens 200, two different focal lengths represented due to the shapes and arrangements of the plurality of nanostructures NS2 may be the first focal length f1 and the second focal length f2, which are the same as that of the first multi-focal meta-lens 100.

The second multi-focal meta-lens 200 may represent the first focal length f1 for light incident to a third region 210, which has a distance equal to or greater than d1 and equal to or less than d2 from a center of the second multi-focal meta-lens 200, and may represent the second focal length f2 for light incident to a fourth region 220, which has a distance equal to or greater than d3 and equal to or less than d4 from the center of the second multi-focal meta-lens 200 and is different from the first focal length f1.

The second multi-focal meta-lens 200 exhibits the same focal length performance for each region as that of the first multi-focal meta-lens 100, but is not completely the same as the first multi-focal meta-lens 100 in a physical structure. The structure of the second multi-focal meta-lens 200 may be physically the same as that of the first multi-focal meta-lens 100. However, the disclosed embodiments are not limited thereto, the shape, size, or arrangement of the plurality of second nanostructures NS2 may be different from those of the plurality of first nanostructures NS1.

The shapes and arrangements of the plurality of first nanostructures N1 and the plurality of second nanostructures NS2, which are respectively provided in the first multi-focal meta-lens 100 and the second multi-focal meta-lens 200, may be set to form a phase profile capable of representing certain desired refractive power with respect to incident light. Such a phase profile may be a phase profile that implements a multi-focal meta-lens implementing the first focal length d1 and the second focal length f2. The phase profile is differently represented according to detailed shape, size, and arrangement of nanostructures. In other words, according to a desired phase profile, the detailed shape, size, and arrangement of the plurality of first nanostructures N1 and the plurality of second nanostructures NS2 may be determined for each position.

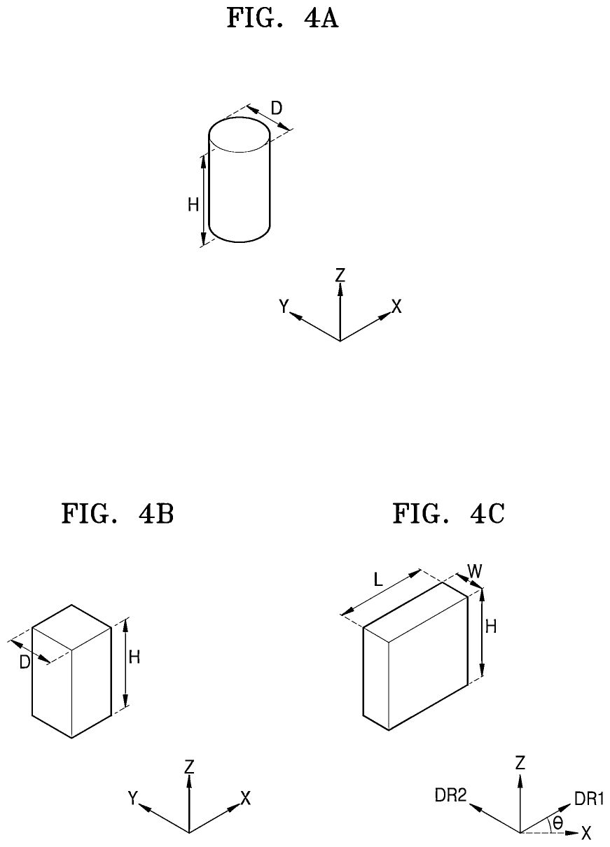

FIGS. 4A to 4C show examples of shapes of a nanostructure provided in an alignment key according to an embodiment.

The first nanostructure NS1 and the second nanostructure NS2 may each independently have a cylindrical shape having a diameter of D and a height of H as shown in FIG. 4A or a square prism shape having a side of D and a height of H as shown in FIG. 4B. D may be differently set according to relative positions of the first nanostructure NS1 and the second nanostructure NS2 in the first multi-focal meta-lens 100 and the second multi-focal meta-lens 200. As such, a desired phase profile may be implemented by adjusting the size of the first nanostructure NS1 and the second nanostructure NS2.

The first nanostructure NS1 and the second nanostructure NS2 may each independently have a columnar shape having an asymmetrical cross section in which a major axis and a minor axis are defined. A major axis direction and a minor axis direction are respectively indicated by DR1 and DR2. For example, as shown in FIG. 4C, the first nanostructure NS1 and the second nanostructure NS2 may each be a rectangular prism shape having a major axis of L, a minor axis of W, and a height of H. The plurality of first nanostructures NS1 may all have the same size, and an arrangement angle θ of a major axis may be differently arranged according to relative positions of the plurality of first nanostructures NS1 in the first multi-focal meta-lens 100. Similarly, the plurality of second nanostructures NS2 may all have the same size, and an arrangement angle θ of a major axis may be differently arranged according to relative positions of the plurality of second nanostructures NS2 in the second multi-focal meta-lens 200. As such, a desired phase profile may be implemented by adjusting the arrangement angle of the first nanostructure NS1 and the second nanostructure NS2.

Each of the first nanostructure NS1 and the second nanostructure NS2 may have a shape dimension of a sub-wavelength, that is, a shape dimension less than a center wavelength of an operating wavelength band. An arrangement pitch of each of the first nanostructure NS1 and the second nanostructure NS2 may also be a sub-wavelength or may be equal to or less than 23 of the center wavelength of the operating wavelength band. A height of each of the first nanostructure NS1 and the second nanostructure NS2 may have a range equal to or greater than a sub-wavelength, and for example, may have a height equal to or greater than ⅙ of a center wavelength.

Each of the first nanostructure NS1 and the second nanostructure NS2 may include a metal or a material with a high refractive index. Each of the first nanostructure NS1 and the second nanostructure NS2 may include Cu, W, TiN, or various other metal materials, or may include c-Si, p-Si, a-Si, a III-V compound semiconductor (e.g., GaAs, GaP, GaN), SiC, TiO₂, or SiN.

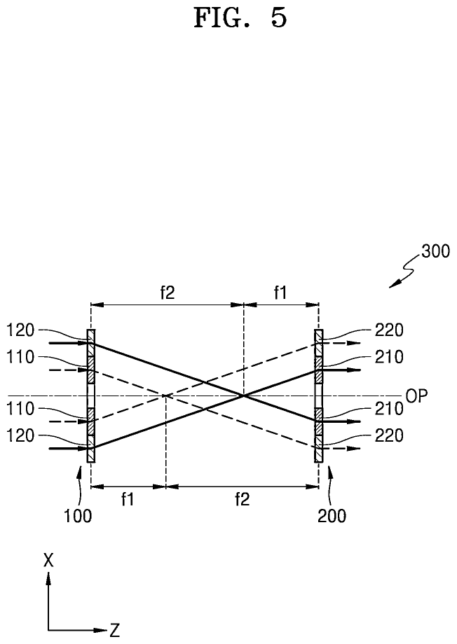

FIG. 5 shows an example of an optical path in a case where a pair of multi-focal meta-lenses are accurately aligned in an alignment key according to an embodiment.

As shown in FIG. 5, a separation distance between the first multi-focal meta-lens 100 and the second multi-focal meta-lens 200, that is, a distance in a Z direction, may be a sum of the first focal length f1 and the second focal length f2. Such a separation distance is referred to as a reference distance. FIG. 5 shows a state in which the first multi-focal meta-lens 100 and the second multi-focal meta-lens 200 are accurately aligned in X and Y directions at positions of such a reference distance. In such an aligned state, a line connecting a center of the first multi-focal meta-lens 100 and a center of the second multi-focal meta-lens 200 is parallel to an optical axis OP.

Parallel light incident to the alignment key 300 is emitted in a form of parallel light having the same angle. An optical path is described in detail as follows. Light incident to the first region 110 of the first multi-focal meta-lens 100 receives an action of positive refractive power representing the first focal length f1, is directed to the fourth region 220 of the second multi-focal meta-lens 200, is incident to the fourth region 220, and then receives an action of positive refractive power of the second focal length f2 represented by the fourth region 220 and is emitted. Light incident to the second region 120 of the first multi-focal meta-lens 100 receives an action of positive refractive power representing the second focal length f2, is directed to the third region 210 of the second multi-focal meta-lens 200, is incident to the third region 210, and then receives an action of positive refractive power of the first focal length f1 represented by the third region 210 and is emitted. In this way, when the first multi-focal meta-lens 100 and the second multi-focal meta-lens 200 of the alignment key 300 are accurately aligned, a light beam that is perpendicularly incident as parallel light to the first multi-focal meta-lens 100 is emitted as parallel light of the same angle when being emitted from the second multi-focal meta-lens 200.

When the first multi-focal meta-lens 100 and the second multi-focal meta-lens 200 are not aligned, for example, being misaligned in the X direction or the Y direction, or according to a change in distance between the first multi-focal meta-lens 100 and the second multi-focal meta-lens 200 in the Z direction, a pattern of light beams passing through the alignment key 300 is changed, and thus, it may be determined whether the first multi-focal meta-lens 100 and the second multi-focal meta-lens 200 are aligned, a degree of misalignment, or a distance in the Z direction.

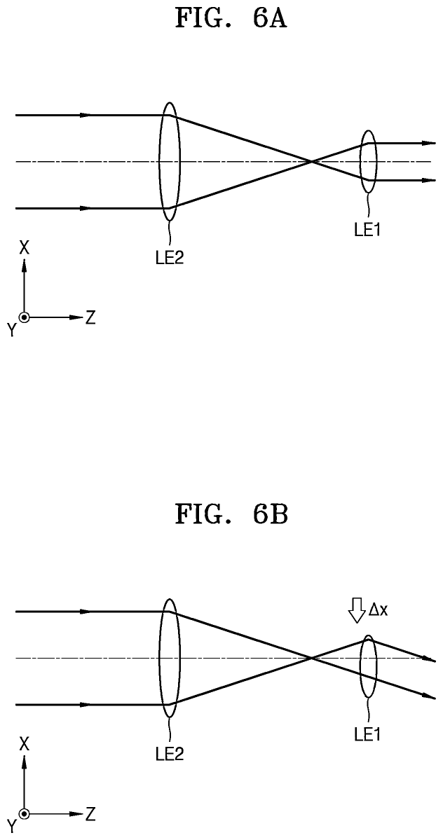

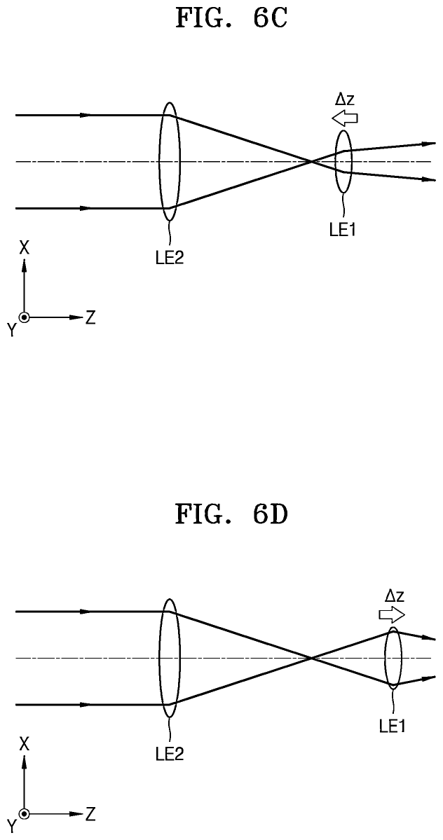

FIGS. 6A to 6D show, according to various alignment states, an example of an action of an equivalent optical system configured by a second region of a first multi-focal meta-lens and a third region of a second multi-focal meta-lens in an alignment key according to an embodiment.

In FIGS. 6A to 6D, the second region 120 of the first multi-focal meta-lens 100 and the third region 210 of the second multi-focal meta-lens 200 are represented by two lenses LE1 and LE2 having different effective diameters and focal lengths.

FIG. 6A is about a state in which the first multi-focal meta-lens 100 and the second multi-focal meta-lens 200 are aligned, FIG. 6B is about a state in which the first multi-focal meta-lens 100 and the second multi-focal meta-lens 200 are misaligned in an X direction, and FIGS. 6C and 6D are respectively about cases where a distance between the first multi-focal meta-lens 100 and the second multi-focal meta-lens 200 in a Z direction is less than and greater than a reference distance in a state where the first multi-focal meta-lens 100 and the second multi-focal meta-lens 200 are aligned.

Optical paths shown in FIGS. 6B to 6D are different from that in FIG. 6A, and the misalignment in X, Y, and Z directions and a distance in the Z direction may be determined by analyzing a beam pattern according to such a change in optical path.

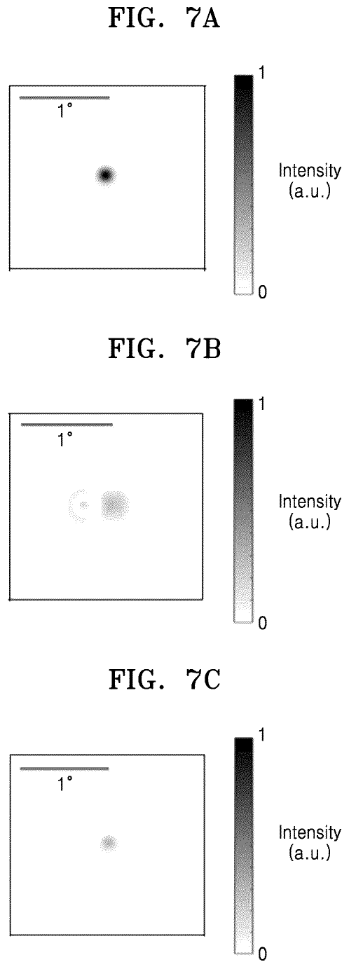

A beam pattern according to an optical path may be measured by using an imaging device. FIGS. 7A to 7C are diagrams of a computer simulation of beam patterns of light imaged by an imaging device, the light transmitting an alignment key, according to various arrangement states of a first multi-focal meta-lens and a second multi-focal meta-lens provided in the alignment key according to an embodiment.

FIG. 7A, which illustrates a beam pattern in a state in which the first multi-focal meta-lens 100 and the second multi-focal meta-lens 200 are aligned, and FIG. 7B, which illustrates a beam pattern in a state in which the first multi-focal meta-lens 100 and the second multi-focal meta-lens 200 are misaligned in the X direction by −2.25 μm, are differently shown, and accordingly, a misalignment state may be determined. Also, FIG. 7C, which shows a beam pattern in a case where a separation distance between the first multi-focal meta-lens 100 and the second multi-focal meta-lens 200 is different from the reference distance by 8 μm, is different from the beam pattern of FIG. 7A, and accordingly, the separation distance in the Z direction may also be determined.

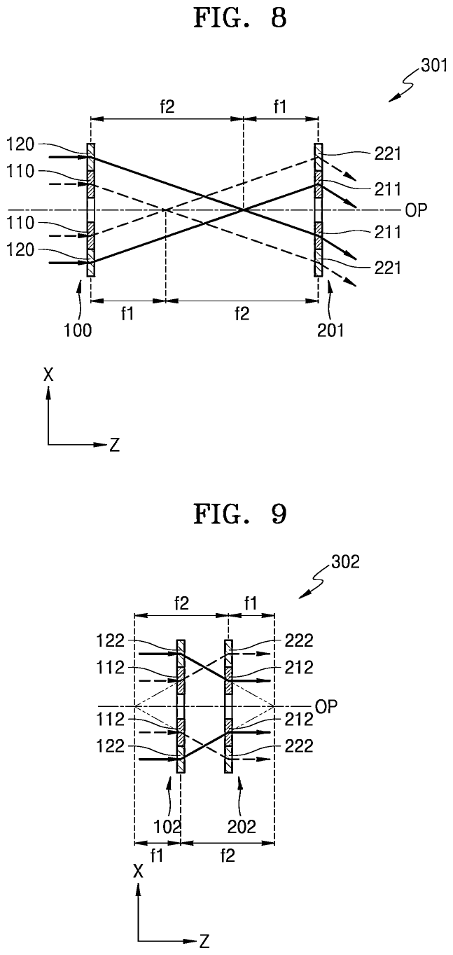

FIG. 8 shows an example of a schematic structure of an alignment key according to another embodiment and an optical path in a case where a pair of multi-focal meta-lenses provided in the alignment key are accurately aligned.

An alignment key 301 may include the first multi-focal meta-lens 100 and a second multi-focal meta-lens 201, and when the second multi-focal meta-lens 201 is compared with the second multi-focal meta-lens 200 shown in FIG. 5, there is a difference in that a shape distribution of a plurality of second nanostructures (not shown) is determined to further have optical performances for deflecting incident light. The second multi-focal meta-lens 201 may include a third region 211 and a fourth region 221, the third region 211 and the fourth region 221 may respectively have the same focal length performances as the first region 110 and the second region 120 of the first multi-focal meta-lens 100, and may have a phase profile further capable of deflecting and emitting light receiving an action of refractive power in a certain direction.

The alignment key 301 may have an advantage of being capable of conveniently setting an arrangement position of an imaging device when a beam pattern by the alignment key 301 is measured by the imaging device.

FIG. 9 shows an example of a schematic structure of an alignment key according to another embodiment and an optical path in a case where a pair of multi-focal meta-lenses provided in the alignment key are accurately aligned.

An alignment key 302 may include a first multi-focal meta-lens 102 and a second multi-focal meta-lens 202. The first multi-focal meta-lens 102 is divided into regions as similar to the first multi-focal meta-lens 100 of FIG. 2, but differs in that a first region 112 has positive refractive power, and a second region 122 has negative refractive power. The second multi-focal meta-lens 202 is divided into regions as similar to the second multi-focal meta-lens 200 shown in FIG. 3, but differs in that a third region 212 has positive refractive power, and a fourth region 222 thereof has negative refractive power.

In such an alignment key 302, a reference distance between the first multi-focal meta-lens 102 and the second multi-focal meta-lens 202 is a difference between the first focal length f1 and the second focal length f2, that is, f2−f1.

When a distance between the first multi-focal meta-lens 102 and the second multi-focal meta-lens 202 is a reference distance, and the first multi-focal meta-lens 102 and the second multi-focal meta-lens 202 are accurately aligned in X and Y directions, parallel light perpendicularly incident to the alignment key 302 is emitted as parallel light having the same angle.

Light incident to the first region 112 of the first multi-focal meta-lens 102 receives an active of negative refractive power representing the first focal length f1, is directed to the fourth region 222 of the second multi-focal meta-lens 202, is incident to the fourth region 222, and then receives an action of positive refractive power of the second focal length f2 represented by the second region 222 and is emitted. Light incident to the second region 122 of the first multi-focal meta-lens 102 receives an action of positive refractive power representing the second focal length f2, is directed to the third region 212 of the second multi-focal meta-lens 202, is incident to the third region 212, and then receives an action of negative refractive power of the first focal length f1 represented by the third region 212 and is emitted.

In this way, when the first multi-focal meta-lens 102 and the second multi-focal meta-lens 202 of the alignment key 302 are accurately aligned, a light beam that is perpendicularly incident as parallel light to the first multi-focal meta-lens 102 is emitted as parallel light of the same angle when being emitted from the second multi-focal meta-lens 202.

In contrast, when the first multi-focal meta-lens 102 is misaligned with the second multi-focal meta-lens 202, or when a distance between the first multi-focal meta-lens 102 and the second multi-focal meta-lens 202 is different from a reference distance, a change occurs in a beam pattern, a degree of misalignment and/or a distance between the first multi-focal meta-lens 102 and the second multi-focal meta-lens 202 may be measured by measuring the change in beam pattern.

As compared to the alignment key 300 in which both of the two regions of each of the first multi-focal meta-lens 100 and the second multi-focal meta-lens 200 have positive refractive power as described in FIG. 5, the alignment key 302 of the embodiment may more sensitively measure degrees of misalignment in the X and Y directions.

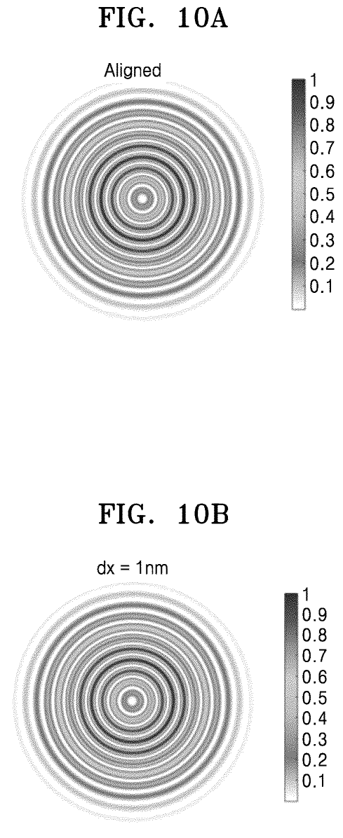

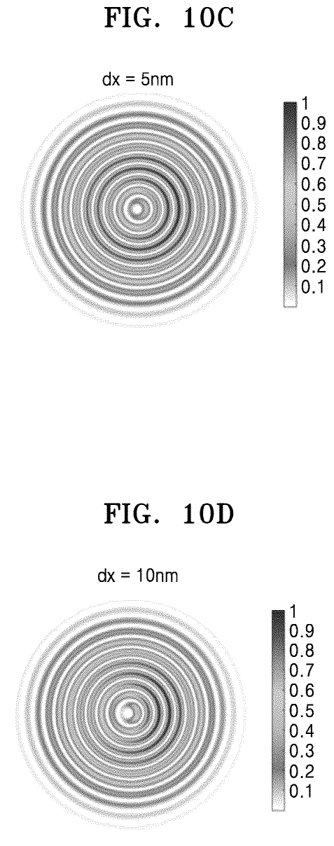

FIGS. 10A to 10D show diagrams of a computer simulation of beam patterns of light imaged by an imaging device, the light transmitting an alignment key, according to a degree in which the first multi-focal meta-lens 102 and the second multi-focal meta-lens 202 provided in the alignment key 302 according to an embodiment are misaligned in the X direction.

In the computational simulation, d1, d2, d3, d4 are respectively 377.5 μm, 432.5 μm, 435 μm, and 500 μm, f1 and f2 are respectively 325 μm and 375 μm, and NA is 0.8.

A horizontal width of a beam pattern of FIGS. 10A to 10D is 0.01 radian, that is, about 0.57°, and it may be seen that a degree of misalignment in the X direction is very sensitively distinguished as compared with FIG. 7B showing a beam pattern for a misalignment state of −2.25 μm.

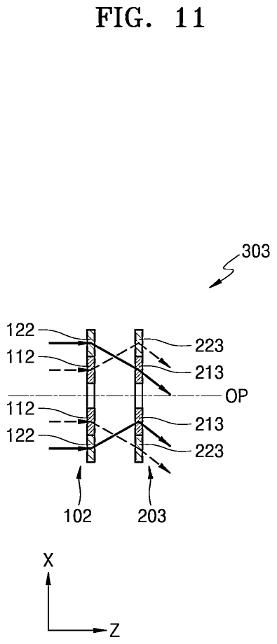

FIG. 11 shows an example of a schematic structure of an alignment key according to another embodiment and an optical path in a case where a pair of multi-focal meta-lenses provided in the alignment key are accurately aligned.

An alignment key 303 may include the first multi-focal meta-lens 102 and a second multi-focal meta-lens 203, and when the second multi-focal meta-lens 203 is compared with the second multi-focal meta-lens 202 shown in FIG. 9, there is a difference in that a shape distribution of a plurality of second nanostructures (not shown) is determined to further have optical performances for deflecting incident light. That is, a third region 213 and a fourth region 223 of the second multi-focal meta-lens 203 may respectively have the same focal length performance as the first region 112 and the second region 122 of the first multi-focal meta-lens 102, and may have a phase profile further capable of deflecting and emitting light receiving an action of refractive power in a certain direction.

The alignment key 303 may have an advantage of being capable of conveniently setting an arrangement position of an imaging device when a beam pattern by the alignment key 303 is measured by the imaging device.

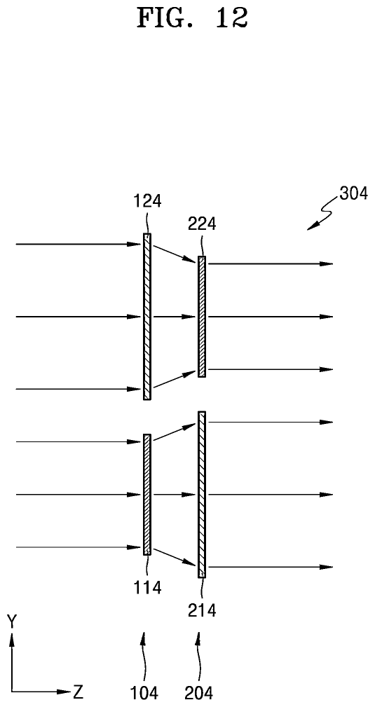

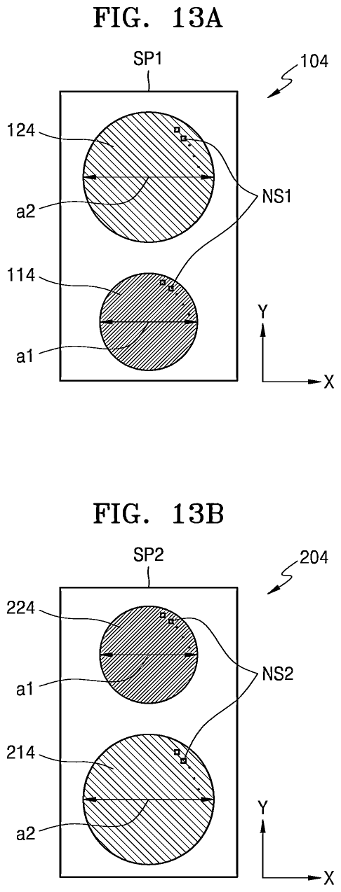

FIG. 12 shows an example of a schematic structure of an alignment key according to another embodiment and an optical path in a case where a pair of multi-focal meta-lenses provided in the alignment key are accurately aligned. FIGS. 13A and 13B are plan views respectively showing schematic structures of a first multi-focal meta-lens and a second multi-focal meta-lens provided in the alignment key of FIG. 12.

An alignment key 304 may include a first multi-focal meta-lens 104 and a second multi-focal meta-lens 204. The first multi-focal meta-lens 104 includes a first region 114 representing the first focal length f1 and a second region 124 representing the second focal length f2, and the second multi-focal meta-lens 204 includes a third region 214 representing the second focal length f2 and a fourth region 224 representing the first focal length f1.

The first multi-focal meta-lens 104 and the second multi-focal meta-lens 204 may be spaced apart from each other in the Z direction, the first region 114 and the second region 124 may be spaced apart from each other in a direction perpendicular to the Z direction, for example, the X direction, and the third region 214 and the fourth region 224 may also be arranged to be spaced apart from each other in the X direction.

The first region 114 and the fourth region 224 may each have negative refractive power, and may each be a circular region having a focal length of f1 and a diameter of a1. The second region 124 and the third region 214 may each have positive refractive power, and may each be a circular region having a focal length of f2 and a diameter of a2. f2 may be greater than f1, and a2 may be greater than a1. The first region 114, the second region 124, the third region 214, and the fourth region 224 may all have the same numerical aperture. However, the disclosed embodiments are not limited thereto.

The first multi-focal meta-lens 104 may include first nanostructures NS1 arranged on the first support layer SP1, and the second multi-focal meta-lens 204 includes second nanostructures NS2 arranged on the second support layer SP2. The shapes and arrangements of the first nanostructures NS1 and the second nanostructures NS2 may be determined to have the region division and focal length relationship described above.

FIG. 12 shows an optical path when the first multi-focal meta-lens 104 and the second multi-focal meta-lens 204 are well aligned without misalignment in the X and Y directions in a state in which a separation distance between the first multi-focal meta-lens 104 and the second multi-focal meta-lens 204, that is, a distance in the Z direction is arranged as f2−f1.

The first region 114 may be arranged to face the third region 214, and the second region 124 is arranged to face the fourth region 224. In a state where the first multi-focal meta-lens 104 and the second multi-focal meta-lens 204 are accurately aligned, a line connecting a center of the first multi-focal meta-lens 104 and a center of the third region 214 and a line connecting the second region 124 and a center of the fourth region 224 are parallel with an optical axis direction (Z direction).

Among parallel beams incident in a direction perpendicular to the first multi-focal meta-lens 104, a beam incident to the first region 114 may receive an action of negative refractive power of the first focal length f1 and is incident to the third region 214 of the second multi-focal meta-lens 204. Next, the incident beam passes through the third region 214 and receives an action of positive refractive power of the second focal length f2 and is emitted as a parallel beam having the same angle as an incident angle to the first multi-focal meta-lens 104.

Among parallel beams incident in a direction perpendicular to the first multi-focal meta-lens 104, a beam incident to the second region 124 may receive an action of positive refractive power of the second focal length f2 and is incident to the fourth region 224 of the second multi-focal meta-lens 204. Next, the incident beam receives an action of negative refractive power of the first focal length f1 and is emitted as a parallel beam having the same angle as the incident angle to the first multi-focal meta-lens 104.

In this way, when the first multi-focal meta-lens 104 and the second multi-focal meta-lens 204 of the alignment key 304 are accurately aligned, a light beam that is perpendicularly incident as parallel light to the first multi-focal meta-lens 104 may be emitted as parallel light of the same angle when being emitted from the second multi-focal meta-lens 204.

In contrast, when the first multi-focal meta-lens 104 is misaligned with the second multi-focal meta-lens 204, or when a distance between the first multi-focal meta-lens 104 and the second multi-focal meta-lens 204 is different from a reference distance, a change occurs in a beam pattern, a degree of misalignment and/or a distance between the first multi-focal meta-lens 104 and the second multi-focal meta-lens 204 may be measured by measuring the change in beam pattern.

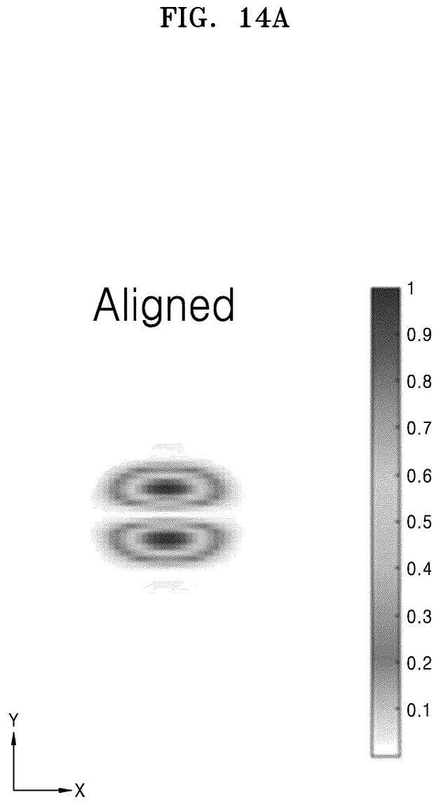

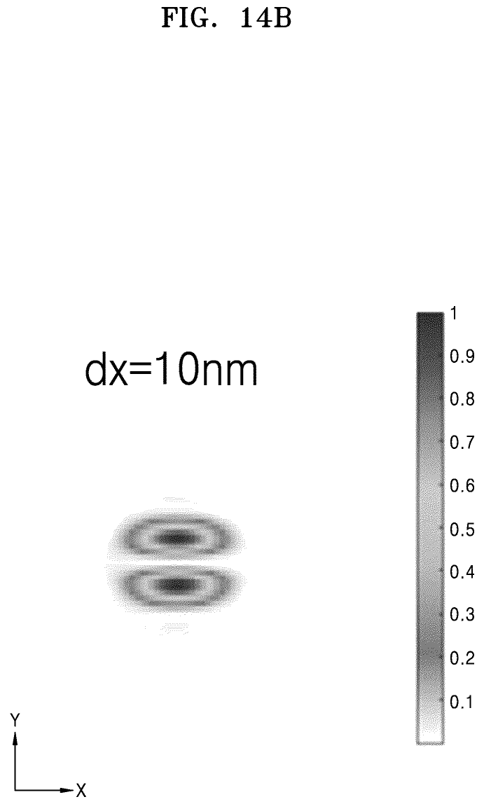

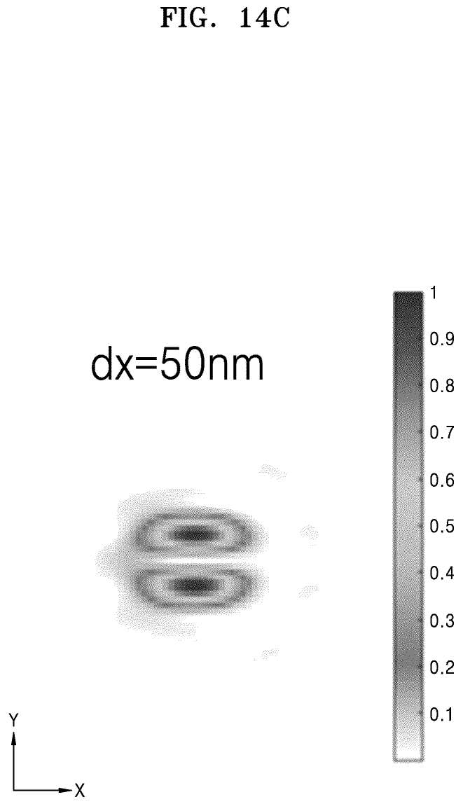

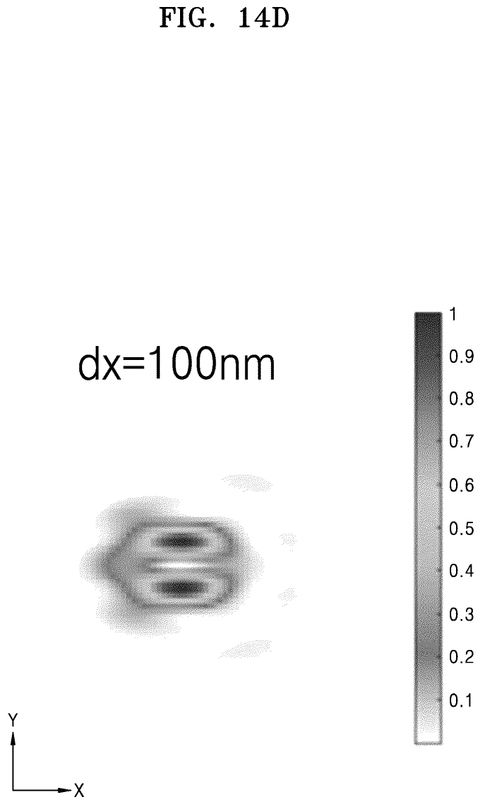

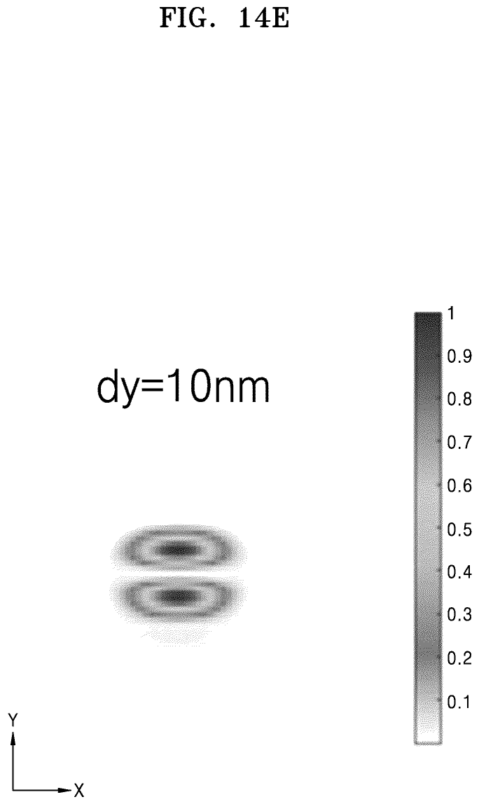

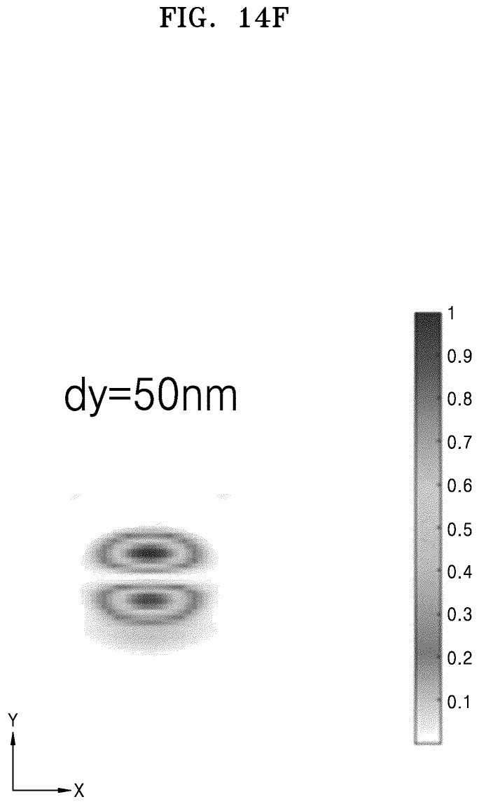

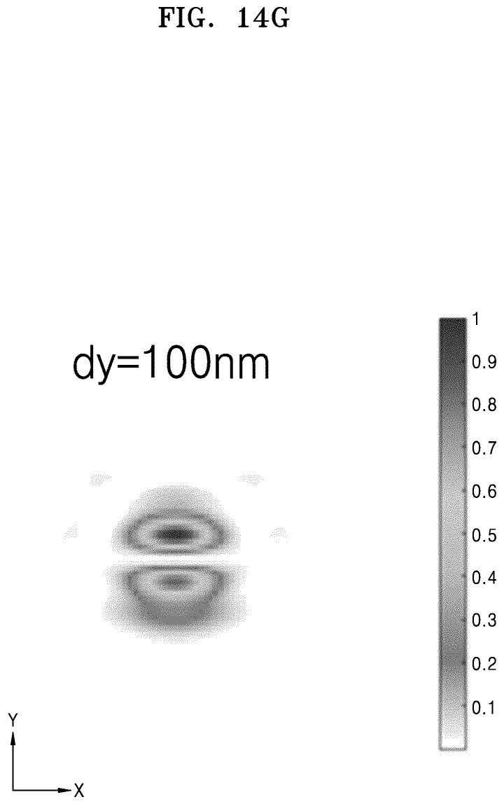

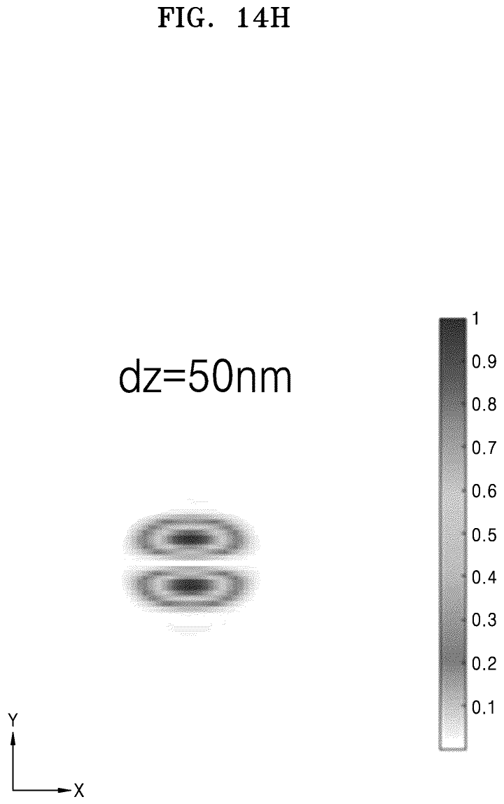

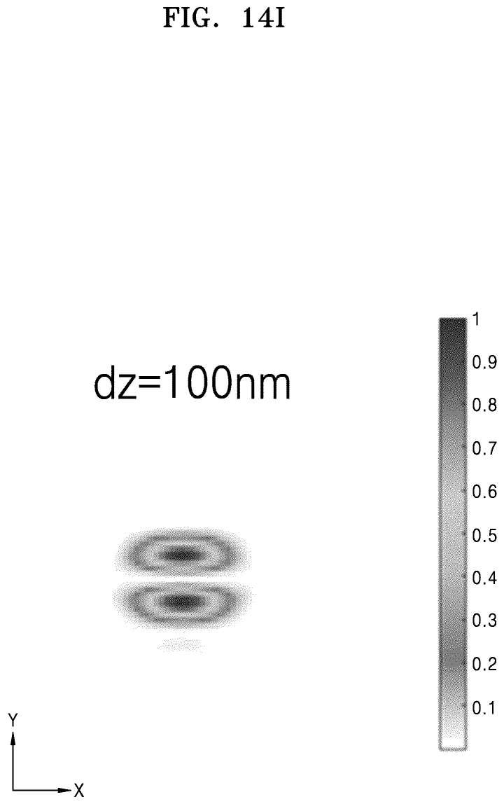

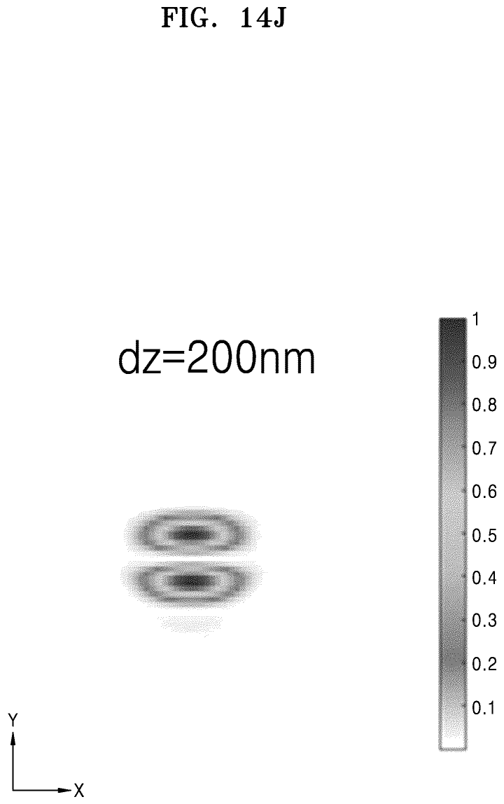

FIGS. 14A to 14J are diagrams of a computer simulation of beam patterns of light imaged by an imaging device, the light transmitting an alignment key, according to various arrangement states of the first multi-focal meta-lens and the second multi-focal meta-lens provided in the alignment key of FIG. 12.

In the computational simulation, a1 and a2 are respectively 1.23 mm and 1.5 mm, and the numerical aperture (NA) of the first region 114, the second region 124, the third region 214, and the fourth region 224 are all 0.8. A wavelength of light is 850 nm.

FIGS. 14A to 14J show far field images by an afocal camera. FIG. 14A is about a state in which the first multi-focal meta-lens 104 and the second multi-focal meta-lens 204 are accurately aligned, FIGS. 14B to 14D respectively show cases of misalignment of 10 nm, 50 nm, and 100 nm in the X direction, at the reference distance, FIGS. 14E to 14G respectively show cases of misalignment of 10 mm, 50 mm, and 100 mm in the Y direction, at the reference distance, and FIGS. 14H to 14J respectively show cases where a distance in the Z direction is different from the reference distance by 50 nm, 100 nm and 200 nm in a state where the first multi-focal meta-lens 104 and the second multi-focal meta-lens 204 are aligned in the X and Y directions.

Similar to the alignment key 301 described with reference to FIG. 8 and the alignment key 303 described with reference to FIG. 11, the alignment key 304 shown in FIG. 12 may also be modified to further have the performance in which the second multi-focal meta-lens 204 deflects light in a certain direction.

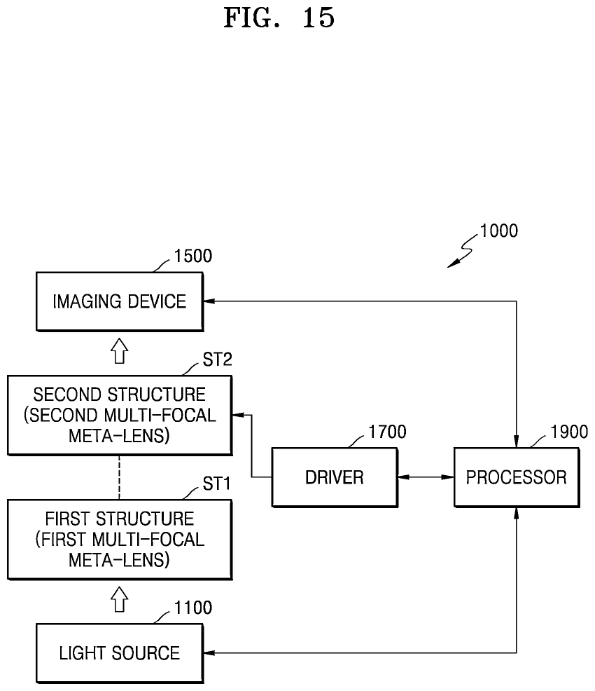

FIG. 15 is a block diagram illustrating a schematic configuration of an alignment apparatus according to an embodiment.

An alignment apparatus 1000 may include the alignment keys of various examples described above. A pair of multi-focal meta-lenses configuring an alignment key may be dividedly arranged in two structures coupled to each other. The alignment apparatus 1000 may also include a light source for irradiating light to an alignment key, and an imaging device for measuring a beam pattern transmitting the alignment key.

The alignment apparatus 1000 may include, for example, a light source 1100, a first structure ST1 including a first multi-focal meta-lens, a second structure ST2 including a second multi-focal meta-lens, an imaging device 1500 measuring a beam pattern after passing through the first multi-focal meta-lens and the second multi-focal meta-lens, a processor 1900 analyzing a degree of misalignment between the first structure ST1 and the second structure ST2 according to a measurement result of the imaging device 1500, and a driver 1700 driving any one of the first structure ST1 and the second structure ST2 under control by the processor 1900.

The first multi-focal meta-lens provided in the first structure ST1 may include a plurality of first nanostructures, and the plurality of nanostructures may have a shape distribution forming two different focal lengths according to regions.

The second multi-focal meta-lens provided in the second structure ST2 may include a plurality of second nanostructures, and the plurality of nanostructures may have a shape distribution forming the two different focal lengths according to regions.

The imaging device 1500 may measure a beam pattern of light passing through the first multi-focal meta-lens and the second multi-focal meta-lens, and may include at least one lens and image sensor. The imaging device 1500 may further include an optical path conversion member for converting a path of light passing through the second multi-focal meta-lens of the second structure ST2 toward the image sensor. Such an optical path conversion member is for convenience of arrangement of the imaging device 1500, and may also be omitted.

As described with reference to FIGS. 8 and 11, the optical path conversion member may be omitted when the second multi-focal meta-lenses 301 303 are designed to have an additional function of deflecting an optical path in a certain direction.

The processor 1900 may analyze an alignment state between the first structure ST1 and the second structure ST2 from a measurement result of the imaging device 1500. When the first structure ST1 and the second structure ST2 are spaced apart from each other in the Z direction, the processor 1900 may analyze a distance in the Z direction as well as a degree of misalignment in the X and Y directions. The processor 1900 may control the driver 1700 according to an analyzed result. The processor 1900 may also control overall driving of the alignment apparatus 1000.

The driver 1700 may change a relative positional relationship between the first structure ST1 and the second structure ST2 under control by the processor 1900. For example, the first structure ST1 may be fixed, the second structure ST2 may be placed on a driving stage, and a position of the second structure ST2 may be adjusted by the driver 1700. However, this is an example, the second structure ST2 may be fixed, the first structure ST1 may be placed on a driving stage, and a position of the first structure ST1 may be adjusted.

Such an alignment apparatus 1000 may include the alignment keys of various examples described above, which may also analyze a misalignment state in the X and Y directions and a distance in the Z direction, and thus the accuracy of coupling the first structure ST1 to the second structure ST2 may be improved.

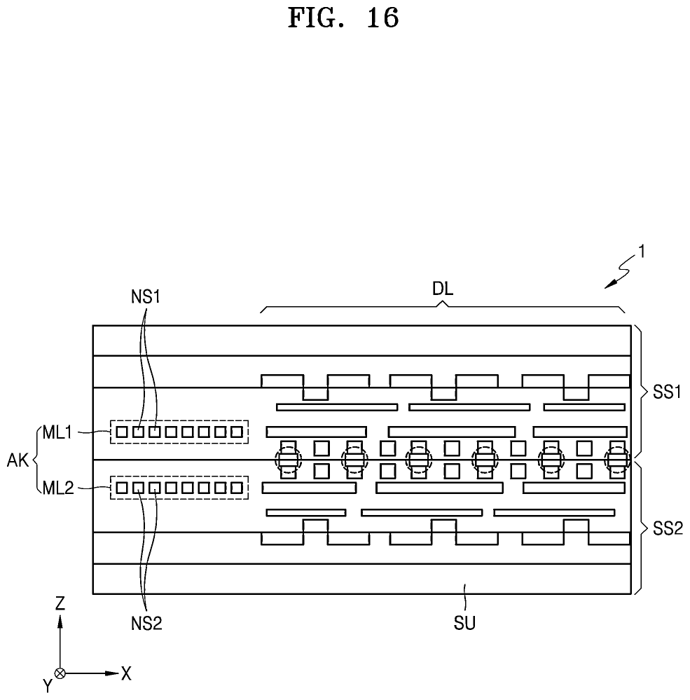

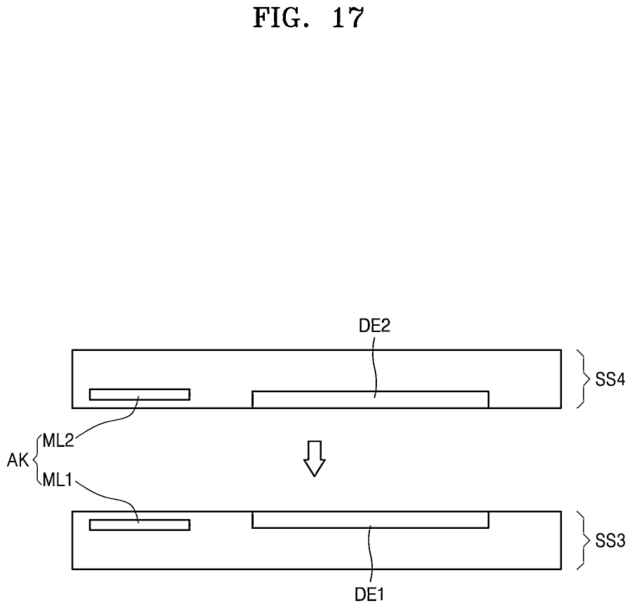

FIG. 16 is a cross-sectional view illustrating a schematic configuration of an apparatus including an alignment key according to an embodiment.

An apparatus 1 may include a substrate SU and an alignment key AK arranged on the substrate SU. The alignment key AK includes a pair of multi-focal meta-lenses, that is, a first multi-focal meta-lens ML1 including a first nanostructure NS1 and a second multi-focal meta-lens ML2 including a second nanostructure NS2. The alignment key AK may include any one of the alignment keys 300, 301, 302, 303, and 304 described above or a structure modified from the alignment keys 300, 301, 302, 303, and 304.

The alignment key AK may be used to precisely couple two separately manufactured electronic elements. The alignment key AK may be dividedly provided in two substrate structures SS1 and SS2 to be coupled to each other. For example, the apparatus 1 has an example structure in which a substrate structure SS1 including the first multi-focal meta-lens ML1 and a substrate structure SS2 including the second multi-focal meta-lens ML2 are coupled to each other. When two substrate structures SS1 and SS2 are coupled to each other, a degree in which the two substrate structures SS1 and SS2 are misaligned in the X and Y directions may be measured from a transmitting or reflecting pattern of light after passing through the alignment key AK, and a distance between the two substrate structures SS1 and SS2 in the Z direction may also be measured. The two substrate structures SS1 and SS2 may be aligned to desired positions or a condition of bonding the two substrate substrates SS1 and SS2 may be modified by reflecting a measurement result. The two substrate structures SS1 and SS2 are directly bonded to each other after being aligned in desired positions. As illustrated by dotted circles, the two substrate structures SS1 and SS2 may be metal bonded or hybrid bonded to each other.

The apparatus 1 formed by coupling the two substrate structures SS1 and SS2 to each other may include a device layer DL including, for example, an insulating pattern, a semiconductor pattern, or a metal pattern. The apparatus may be one of various semiconductor devices, for example, a memory element, a logic element, an image sensor, or an integrated circuit element, and may also be an flat nanostructure-based optical element formed on a wafer substrate, but is not particularly limited thereto.

FIGS. 17 to 20 are diagrams schematically showing examples where an alignment key according to an embodiment is used.

Referring to FIG. 17, face-to-face bonding of two substrate structures SS3 and SS4 is illustrated. The substrate structure SS3 includes a device DE1 and a first multi-focal meta-lens ML1, and the substrate structure SS4 includes a device DE2 and a second multi-focal meta-lens ML2. The first multi-focal meta-lens ML1 and the second multi-focal meta-lens ML2 forms the alignment key AK. A wire layer including metal wires for driving and coupling the two devices DE1 and DE2 may be formed in any one of the substrate structures SS3 and SS4.

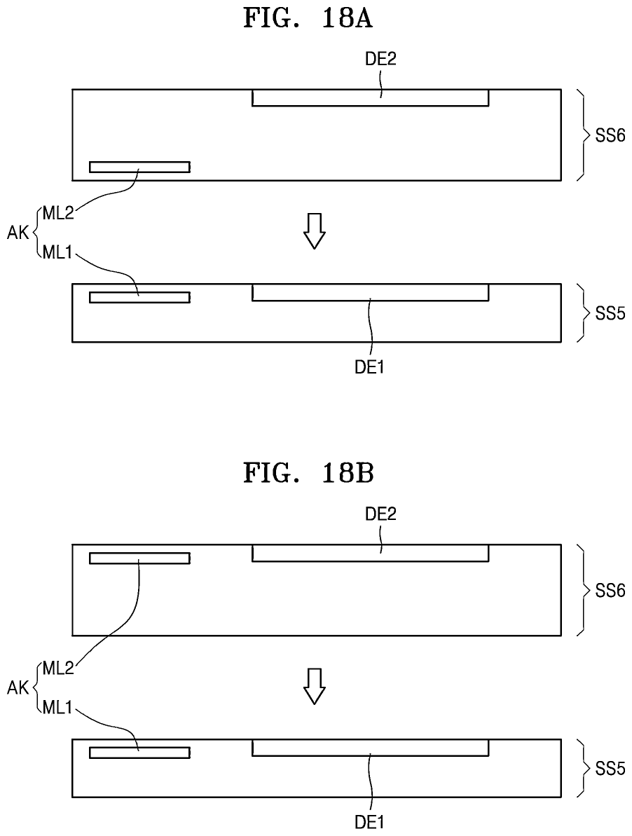

Referring to FIGS. 18A and 18B, face-to-back bonding of two substrate structures SS4 and SS6 is illustrated. The substrate structure SS5 includes a device DE1 and a first multi-focal meta-lens ML1, and the substrate structure SS6 includes a device DE2 and a second multi-focal meta-lens ML2. The first multi-focal meta-lens ML1 and the second multi-focal meta-lens ML2 forms the alignment key AK. A wire layer including metal wires for driving and coupling the two devices DE1 and DE2 may be formed in any one of the substrate structures SS5 and SS6. FIGS. 18A and 18B are different from each other in an arrangement position of the second multi-focal meta-lens ML2. According to an appropriate spacing requirement between the first multi-focal meta-lens ML1 and the second multi-focal meta-lens ML2, as shown in FIG. 18A, the second multi-focal meta-lens ML2 may be arranged on a back surface of the substrate structure SS6, and as shown in FIG. 18B, the second multi-focal meta-lens ML2 may also be arranged on a front surface of the substrate structure SS6.

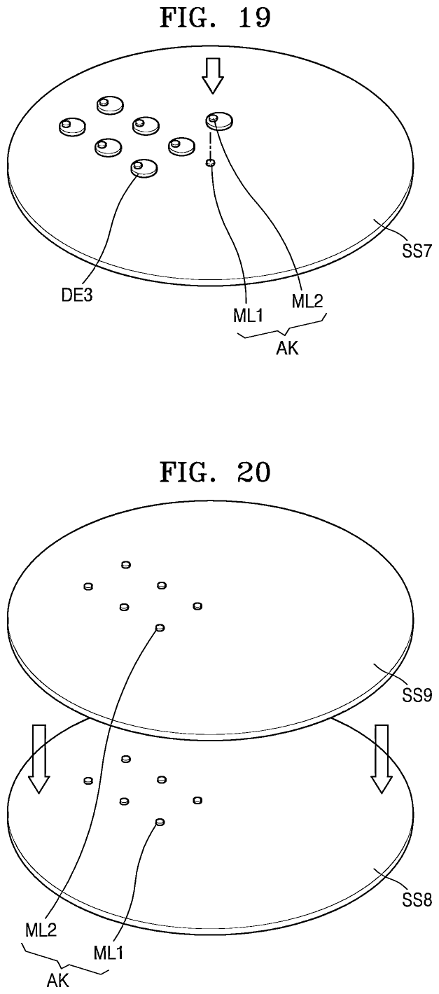

FIG. 19 shows that a device DE3 of the second multi-focal meta-lens ML2 is bonded on the substrate structure SS7 including first multi-focal meta-lenses ML1. The substrate structure SS7 may include devices and wires although not shown in the drawing.

FIG. 20 shows that a substrate structure SS8 including the first multi-focal meta-lenses ML1 and a substrate structure SS9 including the second multi-focal meta-lens ML2 are bonded to each other. The substrate structures SS8 and SS9 may include devices and wires although not shown in the drawing.

The alignment key AK shown in FIGS. 17 to 20 may include any one of the alignment keys 300, 301, 302, 303, and 304 described above or a structure modified from the alignment keys 300, 301, 302, 303, and 304.

An alignment error in stacking of various electronic and optical devices may be accurately measured by using the alignment key described above.

An alignment apparatus including the alignment key described above may measure misalignment in a horizontal direction between two structures to be coupled to each other and together a distance between the two structures, and thus an apparatus formed by coupling the two structures may be more precisely manufactured.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An alignment key comprising:
a first multi-focal meta-lens that comprises a plurality of first nanostructures, the plurality of first nanostructures having a first shape distribution that forms two different focal lengths with respect to a first set of regions in the first multi-focal meta-lens; and
a second multi-focal meta-lens that comprises a plurality of second nanostructures, the plurality of second nanostructures having a second shape distribution that forms the two different focal lengths with respect to a second set of regions in the second multi-focal meta-lens.

2. The alignment key of claim 1,
wherein the two different focal lengths include a first focal length that is a focal length for light incident to a first region of the first set of regions, the first region having a distance equal to or greater than d1 and equal to or less than d2 from a center of the first multi-focal meta-lens,
wherein the two different focal lengths include a second focal length that is a focal length for light incident to a second region of the first set of regions, the second region having a distance equal to or greater than d3 and equal to or less than d4 from the center of the first multi-focal meta-lens,
wherein the second focal length is different than the first focal length,
wherein d1<d2<d3<d4, and
wherein the second multi-focal meta-lens is configured to exhibit a same focal length performance as the first multi-focal meta-lens.

3. The alignment key of claim 2, wherein the second focal length is greater than the first focal length.

4. The alignment key of claim 2, wherein each of the first region and the second region has a same numerical aperture.

5. The alignment key of claim 2, wherein each of the first region and the second region has positive refractive power.

6. The alignment key of claim 2,
wherein the first region has negative refractive power, and
wherein the second region has positive refractive power.

7. The alignment key of claim 2, wherein the second shape distribution is configured so that the second multi-focal meta-lens has an optical performance of deflecting and emitting incident light.

8. The alignment key of claim 1,
wherein the first set of regions comprises:
a first region having negative refractive power, the first region corresponding to a first focal length of the two different focal lengths, the first region having a circular shape with a first diameter; and
a second region spaced apart from the first region in a first direction, the second region having positive refractive power, the second region corresponding to a second focal length of the two different focal lengths, the second region having a circular shape with a second diameter, and
wherein the second set of regions comprises:
a third region spaced apart from and facing the first region in a second direction that is perpendicular the first direction, the third region having positive refractive power, the third region corresponding to the second focal length, the third region having the circular shape with the second diameter; and
a fourth region spaced apart from and facing the second region in the second direction, the fourth region having negative refractive power, the fourth region corresponding to the first focal length, the fourth region having the circular shape with the first diameter.

9. The alignment key of claim 8, wherein each of the first region, the second region, the third region, and the fourth region has a same numerical aperture.

10. An alignment apparatus comprising:
a light source;
a first structure that comprises a first multi-focal meta-lens, the first multi-focal meta-lens comprising a plurality of first nanostructures, the plurality of first nanostructures having a first shape distribution that forms two different focal lengths with respect to a first set of regions in the first multi-focal meta-lens;
a second structure that comprises a second multi-focal meta-lens, the second multi-focal meta-lens comprising a plurality of second nanostructures, the plurality of second nanostructures having a second shape distribution that forms the two different focal lengths with respect to a second set of regions in the second multi-focal meta-lens;
an imaging device configured to measure a beam pattern that is formed after light irradiated from the light source passes through the first multi-focal meta-lens and the second multi-focal meta-lens;
a processor configured to analyze an alignment state between the first structure and the second structure from a measurement result of the imaging device; and
a driver configured to drive at least one of the first structure or the second structure to change a relative positional relationship between the first structure and the second structure, the processor being further configured to control the driver.

11. The alignment apparatus of claim 10,
wherein the two different focal lengths include a first focal length that is a focal length for light incident to a first region of the first set of regions, the first region having a distance equal to or greater than d1 and equal to or less than d2 from a center of the first multi-focal meta-lens,
wherein the two different focal lengths include a second focal length that is a focal length for light incident to a second region of the first set of regions, the second region having a distance equal to or greater than d3 and equal to or less than d4 from the center of the first multi-focal meta-lens,
wherein the second focal length is different than the first focal length,
wherein d1<d2<d3<d4, and
wherein the second multi-focal meta-lens is configured to exhibit a same focal length performance as the first multi-focal meta-lens.

12. The alignment apparatus of claim 11, wherein the second focal length is greater than the first focal length.

13. The alignment apparatus of claim 11, wherein each of the first region and the second region has a same numerical aperture.

14. The alignment apparatus of claim 11, wherein each of the first region and the second region has positive refractive power.

15. The alignment apparatus of claim 14, wherein the processor is further configured to, at a position where the first structure and the second structure are positioned so that a distance between the first multi-focal meta-lens and the second multi-focal meta-lens is a sum of the first focal length and a second focal length, analyze a misalignment state between the first structure and the second structure in a direction perpendicular to an optical axis.

16. The alignment apparatus of claim 11,
wherein the first region has negative refractive power, and
wherein the second region has positive refractive power.

17. The alignment apparatus of claim 16, wherein the processor is further configured to, at a position where the first structure and the second structure are positioned so that a distance between the first multi-focal meta-lens and the second multi-focal meta-lens is a difference between the first focal length and a second focal length, analyze a misalignment state between the first structure and the second structure in a direction perpendicular to an optical axis.

18. The alignment apparatus of claim 10,
wherein the first set of regions comprises:
a first region having negative refractive power, the first region corresponding to a first focal length of the two different focal lengths, the first region having a circular shape with a first diameter; and
a second region spaced apart from the first region in a first direction, the second region having positive refractive power, the second region corresponding to a second focal length of the two different focal lengths, the second region having a circular shape with a second diameter, and
wherein the second set of regions comprises:
a third region spaced apart from and facing the first region in a second direction that is perpendicular the first direction, the third region having positive refractive power, the third region corresponding to the second focal length, the third region having the circular shape with the second diameter; and
a fourth region spaced apart from and facing the second region in the second direction, the fourth region having negative refractive power, the fourth region corresponding to the first focal length, the fourth region having the circular shape with the first diameter.

19. The alignment apparatus of claim 18, wherein each of the first region, the second region, the third region, and the fourth region has a same numerical aperture.

20. The alignment apparatus of claim 10, wherein the processor is further configured to analyze a distance between the first structure and the second structure in an optical axis direction from the measurement result of the imaging device.
